(19) United States
(12) Patent Application Publication
(10) Pub. No.: US 2026/0066437 A1
(43) Pub. Date: Mar. 5, 2026

(54) BATTERY PACK AND METHOD OF MANUFACTURING SAME

(71) Applicant: GM Global Technology Operations LLC, Detroit, MI (US)

(72) Inventors: Anthony Michael Coppola, Rochester Hills, MI (US); William Thomas Kucinski, Windsor (CA); Tyler Talaski, Clarkston, MI (US); Grant Zuccaro, Ray Twp., MI (US); Michael Victor Pyrtko, Ferndale, MI (US); Matthew Kimball, Clarkston, MI (US); James D. Hendrickson, Oxford, MI (US); David J. Brooks, Troy, MI (US); Giles D. Bryer, Northville, MI (US); Mohammad Hamza Kirmani, Troy, MI (US)

(73) Assignee: GM Global Technology Operations LLC, Detroit, MI (US)

(21) Appl. No.: 18/818,877

(22) Filed: Aug. 29, 2024

(51) Int. Cl. H01M 50/291; B60L 50/64; H01M 50/213; H01M 50/249; H01M 50/30; H01M 50/588

(52) U.S. Cl. CPC H01M 50/291; B60L 50/64; H01M 50/213; H01M 50/249; H01M 50/394; H01M 50/588; H01M 2220/20

(57) ABSTRACT

A battery pack, comprising an enclosure having an inner wall and an outer wall opposite the inner wall, a battery cell assembly arranged in the enclosure and including one or more battery cells, one or more stuffers arranged between the inner wall and the battery cell assembly, and a potting arranged in the enclosure and at least partially encapsulating the battery cell assembly and the one or more stuffers.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a battery pack and a method of manufacturing the same.

Battery packs used in electric vehicles include multiple battery modules that can be installed within a protective pack housing. Each battery module includes multiple battery cells installed within a protective module housing. The pack housing and the module housings are designed to protect the battery cells from damage. Existing systems include space between the pack housing, the module housing, and the battery cells that goes unutilized to enhance protection of the battery cells. Shortcomings of these systems will be addressed by one or more aspects of the present disclosure.

### SUMMARY

In one configuration a battery pack is provided and includes an enclosure having an inner wall and an outer wall opposite the inner wall. The battery pack further includes a battery cell assembly arranged in the enclosure and including one or more battery cells, one or more stuffers arranged between the inner wall and the battery cell assembly, and a potting arranged in the enclosure and at least partially encapsulating the battery cell assembly and the one or more stuffers.

The battery pack may include one or more of the following optional aspects. For example, the enclosure further includes an enclosure frame including a first segment, a second segment spaced from the first segment, a third segment coupled to the first and second segments, and a fourth segment spaced from the third segment and coupled to the first and second segments.

According to at least one aspect, the one or more stuffers are arranged in the enclosure between the battery cell assembly and the first and second segments and between the battery cell assembly and the third and fourth segments.

According to another aspect, the enclosure frame further includes a first plate and a second plate spaced from the first plate, the first and second plate both being coupled to the first, second, third, and fourth segments. The one or more stuffers can include a first stuffer arranged between the first segment and the battery cell assembly, a second stuffer arranged between the second segment and the battery cell assembly, a third stuffer arranged between the third segment and the battery cell assembly, and a fourth stuffer arranged between the fourth segment and the battery cell assembly.

According to at least one example, the potting adheres to an inner surface of first plate and an inner surface of the second plate.

According to another example, the potting adheres to the one or more stuffers so that the potting and the one or more stuffers share at least one load path between the enclosure and the battery cell assembly. The one or more stuffers can include an inner core and an outer layer coupled to the inner core. The outer layer can be made of a material that is stiffer than the inner core.

According to at least one aspect, the battery cell assembly further includes a thermal runaway propagation vent network.

In another configuration, a vehicle is provided and includes a vehicle body, an electric motor coupled to the vehicle body, and a battery pack coupled to the vehicle body and communicatively coupled to the electric motor. The battery pack includes an enclosure including an enclosure frame, a first plate coupled to the enclosure frame, and a second plate spaced from the first plate and coupled to the enclosure frame. The battery pack further including a battery cell assembly arranged in and coupled to the enclosure. The battery cell assembly includes one or more battery modules, one or more battery cells arranged in each of the one or more battery modules, and a thermal runaway propagation vent network communicatively coupled to the one or more battery cells. The battery pack further including one or more stuffers arranged between the enclosure frame and the battery cell assembly and a potting arranged in the enclosure and at least partially encapsulating the battery cell assembly and the one or more stuffers.

The vehicle may include one or more of the following optional aspects. For example, the enclosure frame includes a first segment, a second segment spaced from the first segment, a third segment coupled to the first and second segments, and a fourth segment spaced from the third segment and coupled to the first and second segments.

According to at least one aspect, the one or more stuffers are arranged in the enclosure between the battery cell assembly and the first and second segments and between the battery cell assembly and the third and fourth segments.

According to another aspect, the first plate and the second plate are both coupled to the first, second, third, and fourth segments.

According to at least one example, the one or more stuffers include a first stuffer arranged between the first segment and the battery cell assembly, a second stuffer arranged between the second segment and the battery cell assembly, a third stuffer arranged between the third segment and the battery cell assembly, and a fourth stuffer arranged between the fourth segment and the battery cell assembly.

According to another example, the potting adheres to an inner surface of first plate and an inner surface of the second plate.

According to at least one aspect, the potting adheres to the one or more stuffers so that the potting and the one or more stuffers share at least one load path between the enclosure frame and the battery cell assembly.

According to another aspect, the one or more stuffers include an inner core and an outer layer coupled to the inner core. The outer layer can be made of a material that is stiffer than the inner core.

In yet another configuration, a method of manufacturing a battery pack is provided and includes providing an enclosure, arranging a battery cell assembly in the enclosure, arranging one or more stuffers between the battery cell assembly and the enclosure, and introducing potting into the enclosure such that the potting fills gaps between the stuffers, the battery cell assembly, and the enclosure.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a battery pack according to principles of the present disclosure;

FIG. 2 is a top perspective view of the battery pack of FIG. 1;

FIG. 3 is a bottom perspective view of the battery pack of FIG. 1;

FIG. 4 is a bottom perspective view of the battery pack of FIG. 1 with a bottom plate removed and battery module cover removed;

FIG. 5 is a cross-sectional view of the battery pack of FIG. 2;

FIG. 6 is a close-up cross-sectional view of the battery pack of FIG. 3;

FIG. 7 is a close-up cross-sectional view of the battery pack of FIG. 2 including a potting material;

FIG. 8 is a close-up perspective view of a thermal runaway vent network of the battery pack of FIG. 1;

FIG. 9 is a cross-sectional view of a stuffer including an inner core and an outer layer according to principles of the present disclosure; and

FIG. 10 is a flow diagram of a method of manufacturing a battery pack according to principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

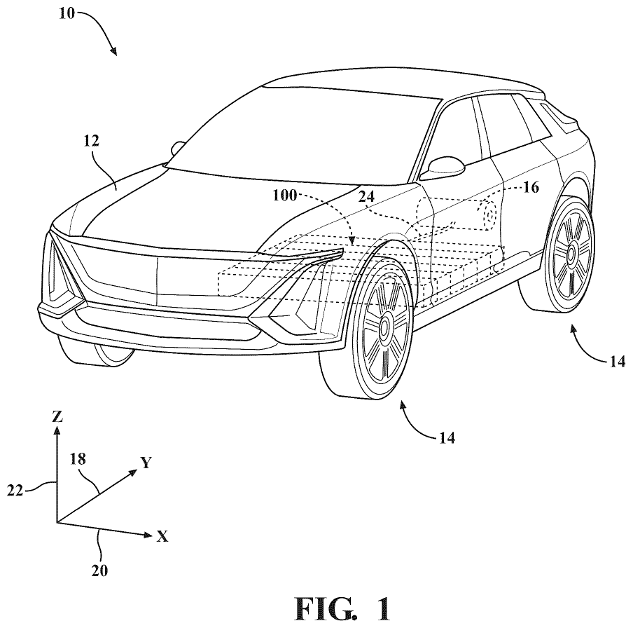

With reference to FIG. 1, a vehicle 10, such as an electric motor vehicle, is provided. The vehicle 10 includes a vehicle body 12, one or more wheels 14, and an electric motor 16 arranged in and/or coupled to the vehicle body 12. The vehicle body 12 extends along a first or longitudinal axis (i.e., fore-aft direction) 18, a second or lateral axis (i.e., cross-car direction) 20, and a third or vertical axis 22. The electric motor 16 can be configured to drive one or more of the one or more wheels 14 to propel the vehicle 10. The vehicle 10 includes a battery pack 100 that can be arranged in and/or coupled to the vehicle body 12 and is communicatively coupled to the electric motor 16 via an electric power cable 24.

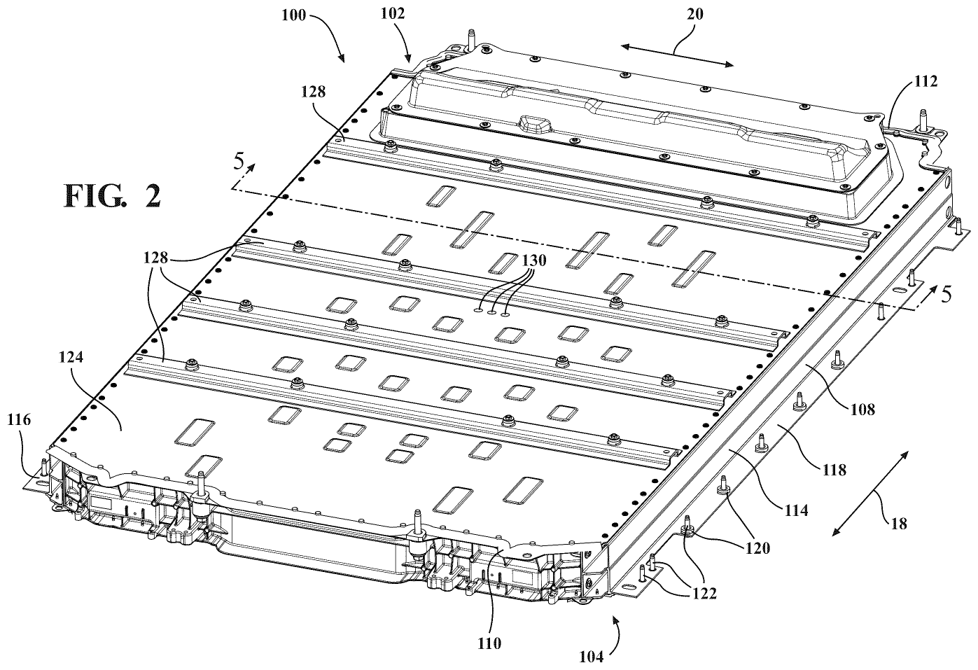

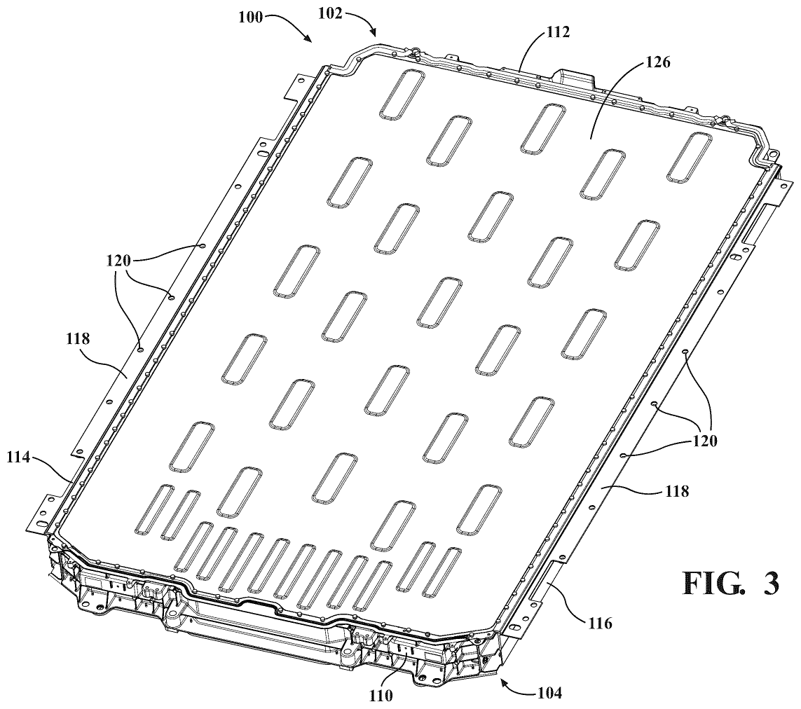

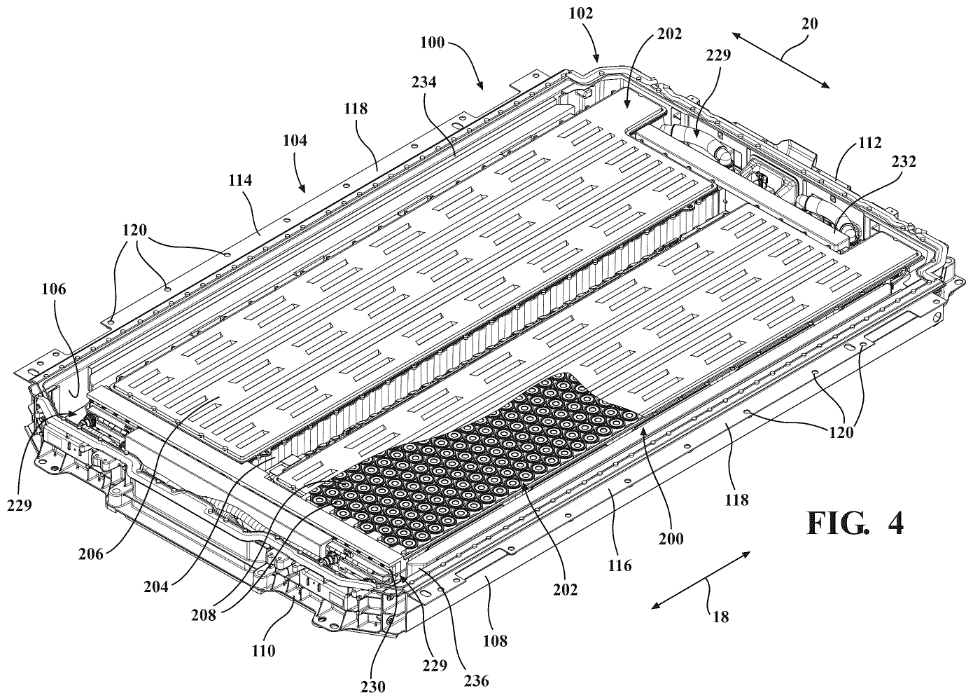

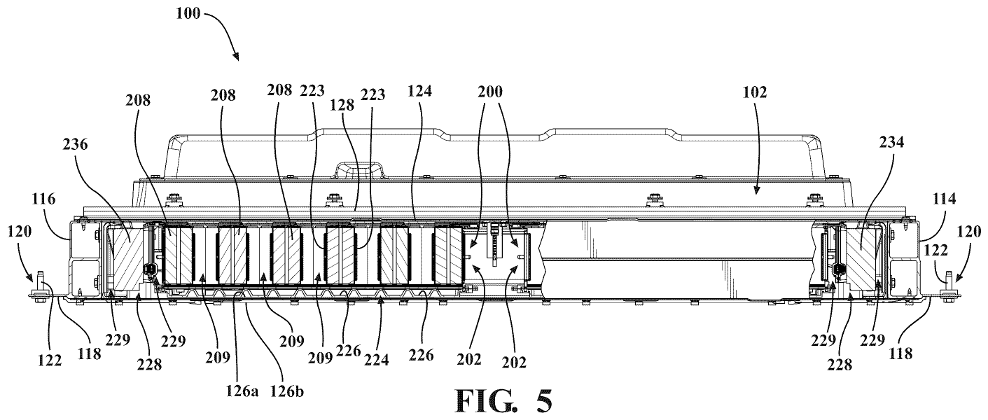

With reference to FIG. 2, the battery pack 100 includes an enclosure 102 that has an enclosure frame 104 including an inner wall 106 (FIG. 4) and an outer wall 108 opposite the inner wall 106. The enclosure frame 104 can include a first segment 110 and a second segment 112 spaced axially from the first segment 110 with respect to the longitudinal axis 18. The enclosure frame 104 further includes a third segment 114 and a fourth segment 116 that is spaced from the third segment 114 with respect to the lateral axis 20. The third and fourth segments 114, 116 can be arranged between and coupled to the first and second segments 110, 112, as shown in FIG. 4. With reference to FIG. 3, the third and fourth segments 114, 116 can be extrusions that each include a flange 118. One or more through holes 120 extend through each of the flanges 118 and are arranged along the flange 118 with respect to the longitudinal axis 18. The one or more through holes 120 can be configured to receive fasteners 122 (FIG. 2) for securing the battery pack 100 to the vehicle body (e.g., a vehicle frame) 12. With reference to FIGS. 2 and 3, the enclosure 102 further includes a first or upper plate 124 and a second or lower plate 126 spaced from the upper plate 124. The upper plate 124 includes an inner surface 124a and outer surface 124b opposite the inner surface 124a, as shown in FIG. 5. Likewise, the lower plate 126 includes an inner surface 126a and an outer surface 126b opposite the inner surface 126a. The upper plate 124 and the lower plate 126 can be coupled to the enclosure frame 104 via welding, fasteners, an adhesive, or using another coupling technique commonly used in the automotive industry. Again, with reference to FIG. 2, the battery pack 100 can include one or more support rails 128 that extend laterally with respect to the lateral axis 20 and are coupled to the upper plate 124 to reinforce the battery pack 100, for example. The enclosure 102 can also include one or more enclosure vents 130 that are configured to allow air to escape from the enclosure 102, as shown in FIG. 2.

The battery pack 100 further includes a battery cell assembly 200 that is configured to be arranged in and coupled to the enclosure 102. With reference to FIG. 4, the battery cell assembly 200 can include one or more battery modules 202 that include a housing 204. The housing 204 can have a removable cover 206 and can be configured so that one or more battery cells 208 (e.g., cylindrical battery cells) can be arranged in the housing 204. In the present illustrative example, with reference to FIG. 5, voids or gaps 209 exist between the one or more battery cells 208. Heretofore, the gaps 209 have gone unutilized, but as will be discussed in more detail below, the gaps 209 can be configured to receive a material that enhances protection of the one or more battery cells 208.

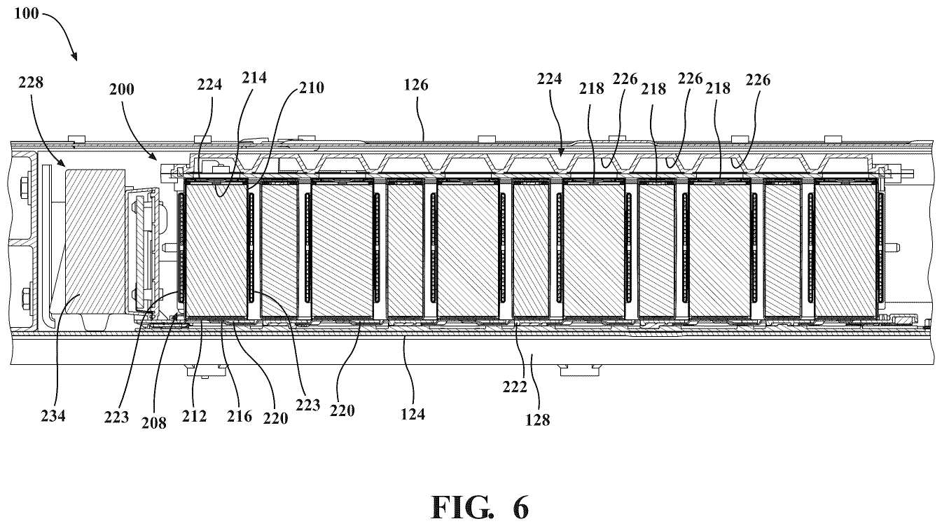

With reference to FIG. 6, each of the battery cells 208 includes a main body 210 that has a first or upper end 212 and a second or lower end 214 spaced from the upper end 212. A terminal 216 can be coupled to and arranged at the upper end 212 of the main body 210. A vent 218 can be coupled to and arranged at the lower end 214 of the main body 210. According to one aspect, the vent 218 can be configured to release gas that builds up within the main body 210 during operation.

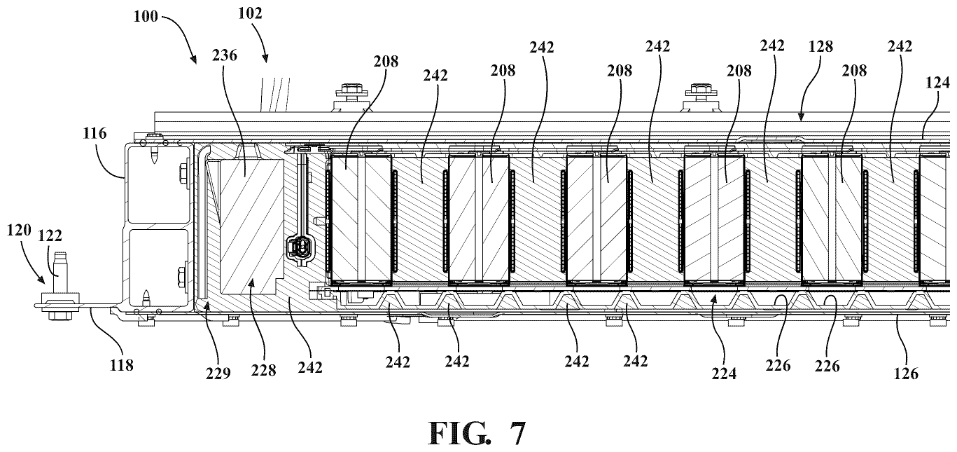

With reference to FIG. 7, one or more bus bars 220 can be coupled to the one or more battery cells 208 and, more particularly, to the terminal 216 of the one or more battery cells 208. The one or more bus bars 220 can also be communicatively coupled to an interconnection board (ICB) 222. According to at least one aspect, cooling ribbons 223 can be arranged with respect to an outer portion (e.g., outer wall) of each the one or more battery cells 208 and can be configured to carry (i.e., circulate) a coolant fluid that removes heat from the one or more battery cells 208 during operation, for example.

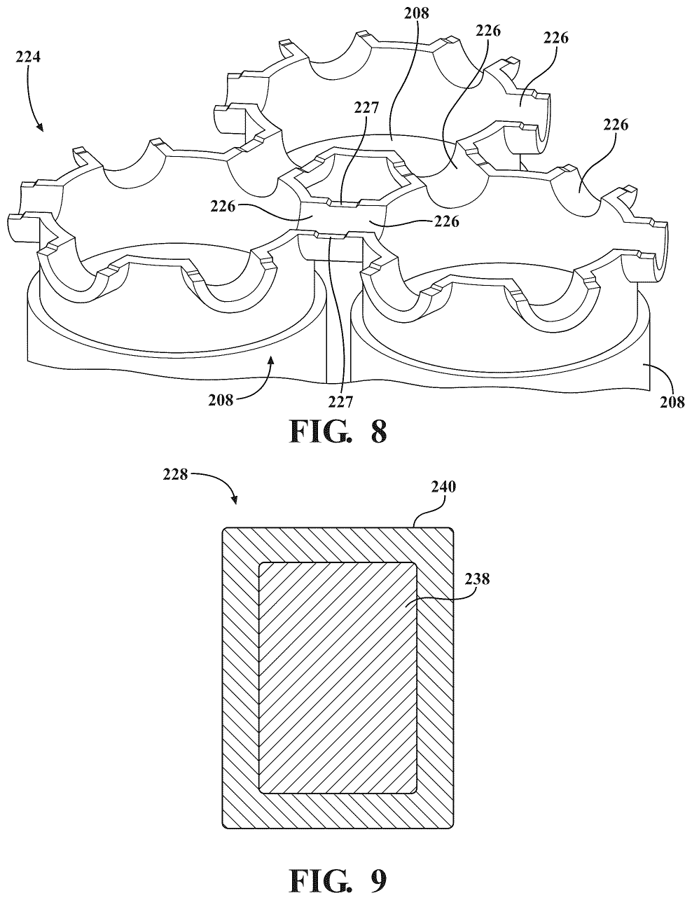

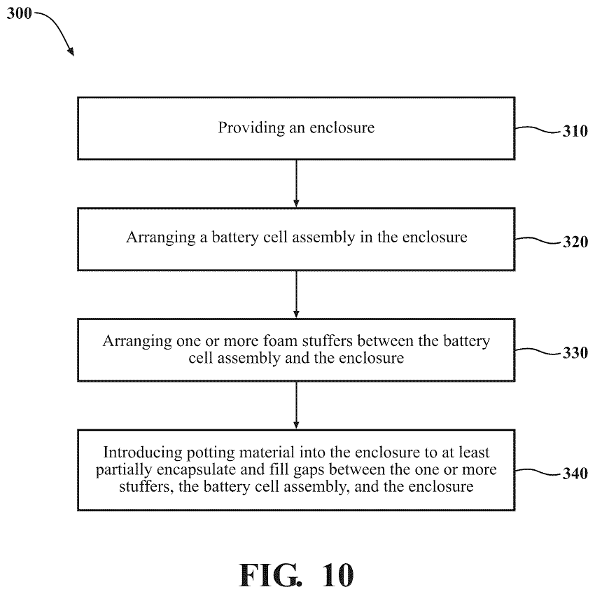

With reference to FIGS. 5 and 7, the battery cell assembly 200 can further include a thermal runaway propagation (TRP) vent network 224 arranged in each of the one or more battery modules 202. As best shown in FIG. 7, the TRP vent network 224 can include one or more vent galleries 226 that are communicatively coupled to one another. The one or more vent galleries 226 can be communicatively coupled with the vent 218 of each of the one or more battery cells 208 and receive gas released from the one or more battery cells 208. Additionally or alternatively, the TRP vent network 224 can be configured to remove heat from the one or more battery cells 208 during operation, for example. According to one aspect, portions of the TRP vent network 224 can be configured to breathe while preventing undesirable water, gas, and other fluids or materials from entering the TRP vent network 224. As will be discussed below, the TRP vent network 224 can be sealed to prevent a potting material from entering the one or more vent galleries 226. However, as shown in FIG. 8, the TRP vent network 224 can include an orifice (i.e., a vent) 227 that allows air (i.e., air bubbles) trapped in the enclosure 102 to escape into the TRP vent network 224 so that the potting material can easily flow throughout the enclosure 102. The potting and the method of filling the battery pack 100 with the potting material will be discussed in more detail below.

With reference again to FIG. 4, the battery pack 100 includes one or more stuffers 228 arranged in the enclosure 102 such that the one or more stuffers 102 are in at least one load path between the enclosure 102 and the battery cell assembly 200. For instance, a first stuffer 230 can be arranged axially between the one or more battery modules 202 and the first segment 110 and a second stuffer 232 can be arranged axially between the one or more battery modules 202 and the second segment 112. The one or more stuffers 228 can additionally or alternatively include a third stuffer 234 arranged laterally between the one or more battery modules 202 and the third segment 114 and a fourth stuffer 236 arranged laterally between the one or more battery modules 202 and the fourth segment 116. According to one aspect, with reference to FIG. 9, the one or more stuffers 228 include an inner core 238 and an outer skin or layer 240. The outer layer 240 can be made of a material that is harder or stiffer than the material of the inner core 238. For instance, the inner core 238 can be made of a low-density polymeric foam or another material that is configured to absorb kinetic energy during a crash event. The inner core 238 can be coated, sprayed, or overmolded with the outer layer 240, for example. Additionally, the inner core 238 can have a closed cell or open cell structure and the outer layer 240 can have a closed cell structure.

In operation, the one or more stuffers 228 can be configured to act as a mechanical fuse to limit or prevent a load on the battery cell assembly 200 and, more particularly, the one or more of the battery cells 208. According to another aspect, the one or more stuffers 228 are spaced at least 10% of the height of the one or more stuffers 228 away from the enclosure 102 to ensure that there is an opening or space 229 between the one or more stuffers 228 and the enclosure 102.

With reference to FIG. 7, the battery pack 100 includes potting 242 throughout the enclosure 102 that at least partially encapsulates the battery cell assembly 200, the TRP vent network 224, and/or the one or more stuffers 228. The potting 242 can be polyurethane-base, epoxy, silicone, or another thermosetting material, for example. According to one aspect, the potting 242 can be a polyurethane-based polymer foam with a tensile modulus of at least 10 MPa, a crush strength of at least 0.5 MPa, and a density of no more than 0.8 g/cc. Potting that foams may be desirable when compared to a non-foaming potting because it has a lower density and thus, reduces overall mass of the battery pack 100. However, in other examples, the non-foaming potting may be used in select regions or throughout the battery pack 100. In general, potting that foams can result in voids (i.e., air pocket or voids), however, the potting 242 can be dispensed into the battery pack 100 from an outer region so that air is directed towards a center region of the battery pack 100. The air directed toward the center of the battery pack 100 can escape through one or more of the enclosure vents 130 (FIG. 2), for example. In general, however, air pockets or voids in a central region of the battery pack 100 do not affect overall structural performance of the battery pack 100. In one configuration, a porous hose (not shown) can be arranged in a portion or throughout the enclosure 102 so that the potting 242 can be consistently and simultaneously dispensed throughout the enclosure 102.

In operation, the battery pack 100 can be configured such that at it provides at least 10% of the load share during a vehicle impact event. At least a portion of the structural rigidity, strength, and energy absorption of the battery pack 100 can be provided by the potting 242 being in contact with the enclosure 102, the battery cell assembly 200, and the one or more stuffers 228. According to one aspect, the potting 242 contacts the upper plate 124 and the lower plate 126 and are joined by a bonding strength of at least 0.5 MPa in shear. The potting 242 and the one or more stuffers 228 can be arranged so that they share a common load path between the enclosure 102 and the battery cell assembly 200. According to another aspect, the one or more stuffers 228 can have a modulus of elasticity and strength that is at least 5 times less than that of the potting 242. This may be desirable to maintain a minimum allowable intrusion during a crash event, for example.

With reference to FIG. 9, a method 300 of manufacturing a battery pack is provided.

At 310, the enclosure 102 is provided. In some instances, the lower plate 126 is removed prior to any of the potting 242 being injected or dispensed into the enclosure 102. In another example, the enclosure 102 can be provided with the upper plate 124 and the lower plate 126 coupled to the enclosure frame 104 prior to any of the potting 242 being injected or dispensed into the enclosure 102.

At 320, the battery cell assembly 200 is provided and arranged in the enclosure 102. For instance, the one or more battery modules 202 can be coupled to the enclosure 102.

At 330, the one or more stuffers are provided and arranged in the enclosure 102. For instance, as introduced above, the one or more stuffers 228 can be arranged so that there are openings 229 between the stuffers 228 and the enclosure 102. The opening 229 allows the potting 242 to easily flow through the enclosure 102 and encapsulate or at least partially encapsulate components inside of the enclosure 102.

At 340, the potting 242 is provided and introduced into the enclosure 102 to encapsulate and fill the gaps between the battery cell assembly 200 and the one or more stuffers 228. In one configuration, the potting 242 can be selectively dispensed in an outer region near the enclosure frame 104 so that the potting 242 can expand towards the center of the battery pack 100. In another configuration, the potting 242 can be introduced through the porous hose (not shown) that can be arranged throughout the enclosure 102. In either configuration, the potting can expand and fill the gaps 229 in the enclosure 102. Note, the first plate 124 can be secured to the enclosure frame 104 prior to or during the expansion of the potting 242.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery pack, comprising:
an enclosure having an inner wall and an outer wall opposite the inner wall;
a battery cell assembly arranged in the enclosure and including one or more battery cells;
one or more stuffers arranged between the inner wall and the battery cell assembly; and
a potting arranged in the enclosure and at least partially encapsulating the battery cell assembly and the one or more stuffers.

2. The battery pack of claim 1, wherein the enclosure further includes an enclosure frame, comprising:
a first segment,
a second segment spaced from the first segment,
a third segment coupled to the first and second segments, and
a fourth segment spaced from the third segment and coupled to the first and second segments.

3. The battery pack of claim 2, wherein the one or more stuffers are arranged in the enclosure between the battery cell assembly and the first and second segments and between the battery cell assembly and the third and fourth segments.

4. The battery pack of claim 2, wherein the enclosure frame further includes a first plate and a second plate spaced from the first plate, the first and second plate both being coupled to the first, second, third, and fourth segments.

5. The battery pack of claim 4, wherein the one or more stuffers include a first stuffer arranged between the first segment and the battery cell assembly, a second stuffer arranged between the second segment and the battery cell assembly, a third stuffer arranged between the third segment and the battery cell assembly, and a fourth stuffer arranged between the fourth segment and the battery cell assembly.

6. The battery pack of claim 4, wherein the potting adheres to an inner surface of first plate and an inner surface of the second plate.

7. The battery pack of claim 1, wherein the potting adheres to the one or more stuffers so that the potting and the one or more stuffers share at least one load path between the enclosure and the battery cell assembly.

8. The battery pack of claim 7, wherein the one or more stuffers include an inner core and an outer layer coupled to the inner core.

9. The battery pack of claim 8, wherein the outer layer is made of a material that is stiffer than the inner core.

10. The battery pack of claim 1, wherein the battery cell assembly further includes a thermal runaway propagation vent network.

11. A vehicle, comprising:
a vehicle body;
an electric motor coupled to the vehicle body; and
a battery pack coupled to the vehicle body and communicatively coupled to the electric motor, comprising:
an enclosure, comprising:
an enclosure frame,
a first plate coupled to the enclosure frame, and
a second plate spaced from the first plate and coupled to the enclosure frame;
a battery cell assembly arranged in and coupled to the enclosure, comprising:
one or more battery modules,
one or more battery cells arranged in each of the one or more battery modules, and
a thermal runaway propagation vent network communicatively coupled to the one or more battery cells;
one or more stuffers arranged between the enclosure frame and the battery cell assembly; and
a potting arranged in the enclosure and at least partially encapsulating the battery cell assembly and the one or more stuffers.

12. The vehicle of claim 11, wherein the enclosure frame includes:
a first segment,
a second segment spaced from the first segment,
a third segment coupled to the first and second segments, and
a fourth segment spaced from the third segment and coupled to the first and second segments.

13. The vehicle of claim 12, wherein the one or more stuffers are arranged in the enclosure between the battery cell assembly and the first and second segments and between the battery cell assembly and the third and fourth segments.

14. The vehicle of claim 12, wherein the first plate and the second plate are both coupled to the first, second, third, and fourth segments.

15. The vehicle of claim 12, wherein the one or more stuffers include a first stuffer arranged between the first segment and the battery cell assembly, a second stuffer arranged between the second segment and the battery cell assembly, a third stuffer arranged between the third segment and the battery cell assembly, and a fourth stuffer arranged between the fourth segment and the battery cell assembly.

16. The vehicle of claim 11, wherein the potting adheres to an inner surface of the first plate and an inner surface of the second plate.

17. The vehicle of claim 11, wherein the potting adheres to the one or more stuffers so that the potting and the one or more stuffers share at least one load path between the enclosure frame and the battery cell assembly.

18. The vehicle of claim 11, wherein the one or more stuffers include an inner core and an outer layer coupled to the inner core.

19. The vehicle of claim 18, wherein the outer layer is made of a material that is stiffer than the inner core.

20. A method of manufacturing a battery pack, comprising:
providing an enclosure;
arranging a battery cell assembly in the enclosure;
arranging one or more stuffers between the battery cell assembly and the enclosure; and
introducing potting into the enclosure such that the potting fills gaps between the stuffers, the battery cell assembly, and the enclosure.
